(19) United States
(12) Patent Application Publication
(10) Pub. No.: US 2018/0104657 A1
(43) Pub. Date: Apr. 19, 2018

(54) METHOD OF MAKING A GOLD ON PALLADIUM GAS SEPARATION MEMBRANE

(71) Applicant: SHELL OIL COMPANY, Houston, TX (US)

(72) Inventors: John Charles SAUKAITIS, Katy, TX (US); Kamal AZAD, Houston, TX (US)

(21) Appl. No.: 15/558,646

(22) PCT Filed: Mar. 16, 2016
(86) PCT No.: PCT/US2016/022550

§ 371 Date: Sep. 15, 2017

Related U.S. Application Data
(60) Provisional application No. 62/134,635, filed on Mar. 18, 2015.

(51) Int. Cl. B01D 69/12; B01D 71/02; B01D 69/04; B01D 67/00; B01D 69/02; C23C 18/31; C23C 18/16

(52) U.S. Cl. CPC B01D 69/125; B01D 71/022; B01D 69/04; B01D 67/0044; B01D 2325/06; B01D 69/02; C23C 18/31; C23C 18/1644; B01D 67/0069

(57) ABSTRACT

A method is provided for preparing a carbon monoxide resistant gold-alloy gas separation membrane system. A palladium layer is provided upon a surface of a tubular porous substrate, wherein the palladium layer has a mean surface roughness (Sa) of less than 2.5 microns, followed by submerging the tubular porous substrate within a solution of chloroauric acid or a salt thereof. A volume of hydrogen peroxide is periodically introduced into the solution while spinning the tubular porous substrate at a set rate and for a time period so as to deposit upon the palladium layer a gold layer of desired uniformity and a desired thickness.

### FILE OF THE INVENTION

This invention relates to an improved method of making a gold-on-palladium gas separation membrane system and the gas separation membrane system produced by the method.

### BACKGROUND OF THE INVENTION

U.S. Pat. No. 8,721,773 describes and claims a method for preparing a gold-palladium alloy gas separation membrane. The gold-palladium membrane is made by providing a palladium layer upon a porous substrate that is abraded to a specific mean surface roughness followed by contacting the abraded palladium surface with a solution of chloroauric acid and hydrogen peroxide to deposit a layer of gold on the abraded palladium surface to produce the gold-palladium membrane. The contacting of the abraded palladium surface with the gold plating solution is performed by circulating it over the surface of the annealed, abraded palladium layer that is on the porous support. In the examples, the porous tube having an abraded palladium layer is suspended within the gold plating solution that is circulated with a peristaltic pump for agitation.

While the method of gold plating disclosed in U.S. Pat. No. 8,721,773 provides for acceptable gold-palladium membranes, there still are a number of problems with its use, which can be improved. For example, it has been found that circulating the gold plating solution with a circulating pump results in the plating of gold on the surfaces of the pump, lines and other equipment that come in contact with the gold plating solution. This results in the loss of significant quantities of expensive gold. Also, the use of the circulating pump to periodically mix hydrogen peroxide with the gold plating solution seems to negatively affect the distribution and uniformity of the gold layer that is laid down on the surface of the abraded palladium layer.

It is desirable to have an improved method of making a supported gold-on-palladium membrane that results in less loss of expensive gold and provides for a more uniformly distributed gold layer that is deposited upon the abraded palladium layer of a supported gold-on-palladium membrane system.

### SUMMARY OF THE INVENTION

Accordingly, provided is a method for preparing a gold-on-palladium gas separation membrane system. In this method, a palladium layer upon a surface of a tubular porous substrate, defined by an outside diameter, a length, and a midpoint of the length, is provided wherein the palladium layer has a mean surface roughness (Sa) of less than 2.5 micron. The tubular porous substrate is then submerged within a volume of a solution of chloroauric acid or a salt thereof. A volume of hydrogen peroxide is periodically introduced into the solution while spinning the tubular porous substrate at a set rate and for a time period so as to deposit upon the palladium layer a gold layer of desired uniformity and a desired thickness.

### BRIEF DESCRIPTION OF THE DRAWINGS

FIG. 1 is a diagram depicting the equipment set-up of the inventive method for gold plating a tubular porous substrate having an abraded palladium membrane layer of a certain mean surface roughness. The diagram shows the plating of a single tubular porous substrate; however, in a typical commercial manufacturing process, multiple tubes would more likely be simultaneously plated by the inventive method within the depicted gold plating bath.

### DETAILED DESCRIPTION OF THE INVENTION

The present invention is an improved method of making a gold-on-palladium membrane system having application for use in gas separations, and, in particular, in the separation of hydrogen from gas streams containing hydrogen. The gold-on-palladium membrane has been found to be particularly resistant to the negative effects of carbon monoxide on the stability of the hydrogen separation capability of the membrane.

The inventive method addresses a number of problems with prior art methods of making gold-on-palladium membranes. One way the inventive method does this is by minimizing contact of the gold plating solution with the surfaces of the equipment used in the step of plating the gold membrane layer on top of the palladium membrane layer. The inventive method provides for the introduction and mixing of the components of the gold plating solution by other than external introduction means, such as by the use of a circulating pump, which the inventive method eliminates. The features of the inventive method provide for improved deposition and distribution of the gold membrane layer upon the surface of the abraded palladium membrane layer of the gold-on-palladium membrane, and they contribute to a lower cost of manufacture due to the reduced amounts of gold that is plated out onto the manufacturing equipment surfaces.

The inventive method solves some of the previously unknown problems with use of the method of preparing a palladium-gold alloy gas separation membrane that is disclosed and claimed in U.S. Pat. No. 8,721,773. This patent is incorporated herein by reference. As noted above, U.S. Pat. No. 8,721,773 discloses a method of making a gold-on-palladium gas separation membrane system by providing a palladium layer onto a porous substrate. The membrane layer is abraded to a specific mean surface roughness followed by contacting the abraded palladium surface with a solution of chloroauric acid and hydrogen peroxide to deposit a layer of gold on the abraded palladium surface so as to produce a gold-on-palladium membrane. The inventive method described and claimed in this specification improves upon the method described in U.S. Pat. No. 8,721,773 by providing a number of features that address certain of the problems associated with the prior art method.

In the inventive method, a tubular porous substrate having a palladium layer with an abraded surface of a certain surface roughness is immersed within a volume of an aqueous solution of chloroauric acid (HAuCl₄) or a salt of chloroauric acid. This aqueous solution is also referred to herein as a plating solution or a gold plating solution or by other similar terminology. While submerged, a volume of hydrogen peroxide (H₂O₂) is periodically introduced into the volume of solution of chloroauric acid or salt while simultaneously spinning the tubular porous substrate. The spinning of the tubular porous substrate is done at a set rate and for a time period so as to deposit a gold layer having a desired uniformity and a desired thickness upon the palladium layer.

It is desirable to introduce the hydrogen peroxide into the volume of chloroauric acid solution by the use of conduit means for introducing a volume of hydrogen peroxide into the plating solution. The conduit means is preferably a tubular conduit that provides fluid communication between a hydrogen peroxide source and a distribution point or location within the volume of plating solution. It is preferred for the volume of hydrogen peroxide to be introduced into the volume of plating solution at a point in close proximity to the tubular porous substrate. An external circulating pump is not used to circulate the plating solution or to mix the hydrogen peroxide with the plating solution, thus, eliminating contacting of the gold plating solution with equipment surfaces external to the plating bath.

The inventive method provides for mixing of the H₂O₂ with the gold plating solution through turbulence and agitation of the plating solution caused by the direct introduction of the H₂O₂ into the plating solution and by the simultaneous spinning of the tubular porous substrate, and, potentially, by shaking or vibrating the plating bath while introducing the H₂O₂ into the plating solution.

The tubular porous substrate can be characterized as having an outside surface or an outside diameter, or both, a length and a midpoint of the length. In the inventive method, it is particularly desirable for the intermittent or periodic introduction of the hydrogen peroxide to be done at a point near to the outside surface of the tubular porous substrate. In particular, for tubular porous substrates having outside diameters of up to 3 inches to 6 inches, the proximity of the point of introduction of the hydrogen peroxide should be within a distance or length from the outside surface of the tubular porous support in the range of upwardly to 6 inches. More specifically, the point of hydrogen peroxide introduction from the outside surface of the tubular porous support is in the range of from 0.25 inches to 6 inches, and, preferably, from 0.5 inches to 5 inches.

It is further desirable for the point of introduction of the hydrogen peroxide to be within a range about the midpoint of the length of the tubular porous substrate. This range is defined as a length that is parallel to the tubular porous substrate and that extends for a distance from the midpoint of the tubular porous substrate in both directions. For tubular porous substrates having outside diameters of up to 6 inches, the range may extend in both directions from the midpoint for a distance or length that is determined by the length of the tubular porous substrate. This range is calculated to be up to 25% of the length of the tubular porous substrate. Preferably, the range about the midpoint of the length of the tubular porous substrate is up to 15% of length of the tubular porous substrate.

The point of introduction of hydrogen peroxide is defined herein to be a location within the volume of plating solution at which the hydrogen peroxide is first contacted and begins to mix with the plating solution. Typically, the point of introduction is at the opening end of a tubular conduit with the opening being relatively small in comparison to the overall volume of plating solution. Though the opening area through which the hydrogen peroxide passes and enters into the plating solution may cover a significant cross sectional area, it is considered herein to be a point source of introduction of hydrogen peroxide.

Instead of the point of introduction being an opening end of a tubular conduit, it may instead or in addition be an opening in the side wall of the conduit, e.g., a hole, through which the liquid hydrogen peroxide passes from inside to outside the conduit and into the plating solution.

The point of introduction of hydrogen peroxide may further include more than one location along the length of the tubular porous substrate. While it is particularly desirable for the point of introduction to be within a range about the midpoint of the length of the tubular porous substrate, it additionally can be at one or multiple locations along the length of the tubular porous substrate and in close proximity to the outside surface of the tubular porous substrate.

During the gold plating step, the tubular porous substrate is suspended within the volume of plating solution by suspension means for suspending the tubular porous substrate and holding it within the volume of plating solution wherein it is turned, rotated, or spun by spinning means for spinning or rotating or turning the tubular porous substrate at a rate and for a time period within the plating solution.

It is preferred for the tubular porous substrate to be oriented within the plating solution so that its axis or length is non-parallel with the horizontal plane. When having this orientation, the axis or length of the tubular porous substrate is either acute and obtuse or right to the horizontal plane at an angle in the range of from 45° to 135°, preferably, from 75° to 105°, and, most preferably, from 80° to 100°.

The spinning rate of the tubular porous substrate within the plating bath is an important parameter of the inventive method for preparing the gold-on-palladium gas separation membrane system. If the rotation rate of the tubular porous substrate within the plating bath is too low or too high, then the desired uniformity and distribution of the gold membrane layer is not obtained. Also, the spinning motion of the tubular porous substrate within the plating bath assists in agitating the plating solution and in mixing the introduced volume of hydrogen peroxide with the plating solution. Thus, the rotating rate of the tubular porous substrate is important and should be high enough to provide for, or at least assist in, mixing of the hydrogen peroxide with the plating solution.

To get the desired results, the rotation rate of the tubular porous substrate within the plating bath is in the range of from 20 rotations per minute (rpm) to 150 rpm. Preferably, the rotation rate of the tubular porous substrate is in the range of from 25 rpm to 120 rpm, and, more preferably, it is from 30 rpm to 90 rpm.

A palladium surface having a mean surface roughness (Sa) in the range of from 0.2 microns to 2.5 microns is plated with gold by employing the chloroauric acid and hydrogen peroxide solution. In accordance with the invention, the palladium surface prior to plating with the chloroauric acid and hydrogen peroxide solution, must have a mean surface roughness (Sa) in the range of from 0.2 microns up to 2.5 microns. Preferably, the mean surface roughness (Sa) is between 0.3 microns and 1.5 microns, more preferably between 0.4 microns and 1.2 microns.

The mean surface roughness or arithmetical mean height (Sa) is a known measurement for measuring the roughness of a surface and can be readily determined with the use of an optical profilometer. Any commercially available optical profilometer may be used. An example of such a commercially available optical profilometer is the ST400 3D Profilometer, which is marketed and sold by Nonovea.

Following the abrading of the palladium surface to the desired surface roughness, one or more layers of gold are deposited on the palladium surface by submersing the tubular porous substrate having the specified mean surface roughness within a volume of the plating solution that is an aqueous solution comprising chloroauric acid (HAuCl₄) and hydrogen peroxide.

The plating solution may also comprise a salt of chloroauric acid, such as the potassium and sodium salts thereof.

The concentration of chloroauric acid in the gold plating solution will generally be in the range of from 0.001 wt % to 0.2 wt %, preferably from 0.005 wt % to 0.05 wt %, based on the weight of the solution.

As described above, a volume of hydrogen peroxide is periodically introduced into the gold plating solution. The hydrogen peroxide may be in the form of an aqueous solution having, for instance, a concentration of hydrogen peroxide in the range of from about 5 vol. % upwardly to 100 vol. % hydrogen peroxide. Preferably, the hydrogen peroxide solution has a concentration of hydrogen peroxide in the range of from 10 vol. % to 80 vol. %, and, more preferably, from 20 vol. % to 60 vol. %.

The amount of hydrogen peroxide periodically added to the gold plating solution during the gold plating step is such as to provide a concentration of hydrogen peroxide in the gold plating solution that is, generally, in the range of from 0.01 wt % to 0.1 wt %, preferably from 0.01 wt % to 0.05 wt %.

The periodic addition of the volume of hydrogen peroxide into the plating solution during the gold plating step is done at time intervals in the range of from 0.25 hrs to 4 hrs. It is preferred to introduce the volume of hydrogen peroxide into the plating solution at time intervals of from 0.5 hrs to 2 hrs, and, more preferably, from 0.75 hrs to 1.5 hrs.

The volume of hydrogen peroxide that is introduced at each interval into the plating solution is ultimately such as to provide the concentration of the hydrogen peroxide in the plating solution to be within the ranges discussed above. Accordingly, the volume of hydrogen peroxide solution added to the plating solution at each interval as a percentage of the volume of plating solution within the plating bath can be in the range of from 0.001 vol. % of the total volume of plating solution of the plating bath to 0.2 vol. %. More typically, the volume of hydrogen peroxide solution per total volume of plating solution of the plating bath added to the plating solution is in the range of from 0.005 vol. % to 0.1 vol. %, and, most typically, from 0.01 vol. % to 0.05 vol. %.

The plating step, or the total time that the tubular porous substrate is submerged within the plating solution, is typically conducted for a plating time period of at least 1 hr and up to 20 hrs. It is preferred to conduct the plating step for a plating time period in the range of from 2 hr to 15 hrs, and, more preferred, from 3 hrs to 10 hrs.

The gold can be layered, i.e., deposited in multiple layers, or deposited in one layer. The thickness of the gold coating in the gold-on-palladium membrane can range from a fraction of a micron, (e.g., 0.1 micron) to 7 microns or more, preferably from 0.25 micron to 7 microns.

The gold-on-palladium membrane can be supported upon a porous substrate that is coated with an intermetallic diffusion barrier. In this embodiment, an intermetallic diffusion barrier is applied to a porous substrate; one or more layers of palladium or a palladium alloy is deposited on the intermetallic diffusion barrier; the surface of the palladium layer is abraded using an abrasive media to achieve a desired surface roughness; one or more layers of gold are then deposited on the palladium layer by contacting the abraded palladium layer with the plating solution. After deposition of each gold layer on a palladium layer, the gold layer is heat treated, i.e., annealed, to produce the gold-on-palladium gas separation membrane system coated porous support.

Porous supports which may be employed in this embodiment of the inventive method include any porous metal material that is suitable for use as a support for the intermetallic diffusion barrier and the layer(s) of palladium and/or gold-on-palladium membrane.

The porous support may be of any shape or geometry; provided, that, it has a surface that permits the application thereto or deposition thereon of the intermetallic diffusion barrier and layer(s) of palladium, palladium alloys and gold. Such shapes can include planar or curvilinear sheets of the porous metal material having an undersurface and a top surface that together define a sheet thickness, or the shapes can be tubular, such as, for example, rectangular, square and circular tubular shapes that have an inside surface and an outside surface that together define a wall thickness and with the inside surface of the tubular shape defining a tubular conduit.

The porous metal material can be selected from any of the materials known to those skilled in the art including, but not limited to, the stainless steels, such as, for example, the 301, 304, 305, 316, 317, and 321 series of stainless steels, the HASTELLOY® alloys, for example, HASTELLOY® B-2, C-4, C-22, C-276, G-30, X and others, and the INCONEL® alloys, for example, INCONEL® alloy 600, 625, 690, and 718. The porous metal material, thus, can comprise an alloy that is hydrogen permeable and which comprises iron and chromium. The porous metal material may further comprise an additional alloy metal selected from the group consisting of nickel, manganese, molybdenum and any combination thereof.

One particularly desirable alloy suitable for use as the porous metal material can comprise nickel in an amount in the range of upwardly to about 70 weight percent of the total weight of the alloy and chromium in an amount in the range of from 10 to 30 weight percent of the total weight of the alloy. Another suitable alloy for use as the porous metal material comprises nickel in the range of from 30 to 70 weight percent, chromium in the range of from 12 to 35 weight percent, and molybdenum in the range of from 5 to 30 weight percent, with these weight percents being based on the total weight of the alloy. The Inconel alloys are preferred over other alloys.

The thickness (e.g. wall thickness or sheet thickness as described above), porosity, and pore size distribution of the pores of the porous metal substrate are properties of the porous support selected in order to provide a gas separation membrane system of the invention that has the desired properties and as is required in the manufacture of the gas separation membrane system of the invention.

It is understood that, as the thickness of the porous support increases, when it is used in hydrogen separation applications, the hydrogen flux will tend to decrease. The operating conditions, such as pressure, temperature and fluid stream composition, may also impact the hydrogen flux. But, in any event, it is desirable to use a porous support having a reasonably small thickness so as to provide for a high gas flux therethrough. The thickness of the porous substrate for the typical application contemplated hereunder can be in the range of from about 0.1 mm to about 25 mm, but, preferably, the thickness is in the range of from 1 mm to 15 mm, and, more preferably, from 2 mm to 12.5 mm, and, most preferably, from 3 mm to 10 mm.

The porosity of the porous metal substrate can be in the range of from 0.01 to about 1. The term porosity is defined as the proportion of non-solid volume to the total volume (i.e. non-solid and solid) of the porous metal substrate material. A more typical porosity is in the range of from 0.05 to 0.8, and, even, from 0.1 to 0.6.

The pore size distribution of the pores of the porous metal substrate can vary with the median pore diameter of the pores of the porous metal substrate material typically being in the range of from about 0.1 micron to about 50 microns. More typically, the median pore diameter of the pores of the porous metal substrate material is in the range of from 0.1 micron to 25 micron, and, most typically, from 0.1 micron to 15 microns.

The abraded palladium surface of the tubular porous substrate should have a particular surface roughness before depositing on it the one or more layers of gold with the use of the plating solution comprising chloroauric acid or salts thereof and hydrogen peroxide.

The deposition of the layer(s) of gold on the palladium layer(s) is done by electroless plating in a gold plating bath in which a solution containing water, chloroauric acid and hydrogen peroxide is contacted with the surface of the annealed, abraded palladium layer(s) on the tubular porous substrate.

The gold plating is continued until a gold layer having between 1 wt % and 20 wt. % of the total palladium layer(s) is obtained. Preferably, the gold will comprise between 5 wt % and 20 wt % of the total palladium layer(s), more preferably between 8 wt % and 10 wt % of the total palladium layer(s). The aforementioned percentages of gold can be applied in one or more plating operations.

The thickness of the gold layer or coating can vary from a fraction of a micron, e.g. 0.1 micron or 0.25 micron, up to 7 microns, depending on the number of gold plating steps or the total length of gold deposition. Preferably the thickness of the gold layer is from 0.20 micron to 5 microns, more preferably from 0.25 micron to 2 microns.

Gold can be deposited on the palladium in one layer or deposited as one layer of alternating layers of palladium and gold.

Following deposition of the gold layer(s) on the palladium layer(s), the resulting metal layers are preferably subjected to an annealing operation sufficient to achieve some intermetallic diffusion of the gold layer into the palladium layer forming a palladium-gold alloy. Suitable annealing temperatures for forming the palladium-gold alloy are in range of from 400° C. to 800° C., preferably from 500° C. to 600° C. In a preferred embodiment, annealing is accomplished by slowly heating the porous substrate with the palladium and gold layers to a temperature in the range of from about 500° C. to or about 600° C. in a hydrogen atmosphere.

The gold-on-palladium membrane layer has a thickness between 1 micron and 10 microns, preferably between 2 microns and 10 microns. The gold-on-palladium membrane layer typically comprises from between 0.2 wt % and 20 wt % gold based on the total weight of the alloy, preferably between 5 wt % and 20 wt % gold based on the total weight of the alloy.

The gold-on-palladium gas separation membrane system prepared by the method of the invention can be used in a wide variety of applications, especially those involving the separation of hydrogen from gas streams that comprise other gases, including gases containing concentrations of sulfur compounds, for example, those selected from the group of gases consisting of carbon dioxide, water, methane or mixtures thereof.

The gold-on-palladium gas separation membrane system is especially useful in the separation of H₂ from synthesis gas streams due to its high resistance to poisoning by carbon monoxide.

In the above applications, the temperature conditions can be in the range upwardly to 600° C., for instance, in the range of from 100° C. to 600° C., and the pressure conditions can be in the range upwardly to 60 bar, for instance, in the range of from 1 to 40 bar.

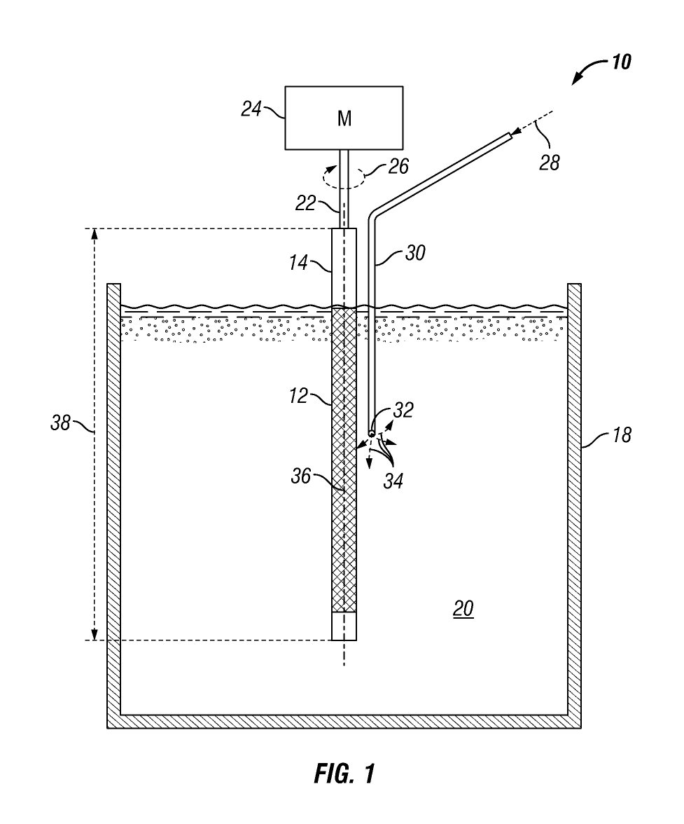

Presented in FIG. 1 is a diagram of equipment system 10 that provides for gold plating onto an abraded palladium membrane layer 12 (shown by cross-hatching) that is on the surface of a tubular porous substrate 14. The palladium membrane layer is abraded so that its mean surface roughness is up to or less than 2.5 microns, and, preferably above 0.5 microns and less than 1.5 microns.

Vessel 18 holds a volume of gold plating solution 20 into which tubular porous substrate 14 is immersed. The gold plating solution 20 comprises an aqueous solution of chloroauric acid (HAuCl₄) at a concentration in the range of from 0.001 wt % to 0.2 wt % and hydrogen peroxide at a concentration in the range of from 0.01 wt % to 0.1 wt %.

The source of the hydrogen peroxide in gold plating solution 20 may be from the periodic or intermittent addition of one or more volumes of hydrogen peroxide to the gold plating solution 20 during the step of plating the abraded palladium membrane layer 12 with the gold membrane layer, or a portion of the hydrogen peroxide content of gold plating solution 20 may be in the originally supplied or prepared gold plating solution that is placed in vessel 18.

Tubular porous substrate 14 is held in place and suspended within the volume of gold plating solution 20 by connection or coupling 22. Coupling 22 is operatively connected to tubular porous substrate 14 and provides suspension means for suspending tubular porous substrate 14 within the volume of gold plating solution 20 wherein it is turned, rotated or spun.

Coupling 22 is also operatively connected to motor 24. Motor 24 provides spinning means for spinning or rotating or turning tubular porous substrate 14 within volume of gold plating solution 20 at a rate and for a time period so as to deposit upon the abraded palladium membrane layer 12 a gold layer of desired uniformity and desired thickness.

The rotation or spinning of the tubular porous substrate 14 is depicted by arrow 26. The rate at which tubular porous substrate 14 is spun within volume of gold plating solution 20 is in the range of from 20 rpm to 150 rpm. The tubular porous substrate 14 is spun within volume of gold plating solution 20 for a time period in the range of from 1 hour to 20 hours, preferably, from 2 hours to 15 hours.

During the spinning of tubular porous substrate 14 one or more volumes of hydrogen peroxide 28 is periodically introduced into volume of gold plating solution 20 through tube 30. Tube 30 provides conduit means for introducing the hydrogen peroxide into the volume of gold plating solution 20.

Tube 30 provides fluid communication between a source of hydrogen peroxide 28 and distribution point or location 32 at which point it is distributed or mixed with the volume of gold plating solution 20 as depicted by arrows 34. Distribution point 32 is in proximity to the outer surface of tubular porous substrate 14 and within a range about midpoint 36 of length 38 of tubular porous substrate 14.

The following example is provided to further illustrate the invention, but it should not be construed as limiting its scope.

### Example (Gold-On-Palladium Membrane)

This Example describes the preparation of a gold-on-palladium hydrogen separation membrane system.

Initial Preparation of Tubular Porous Support

The initial preparation of the 1 inch OD×15 inch length×0.1 inch wall porous Hastelloy X stainless tubular support of this Example 2 was the same as that described in Example 1.

Palladium Plating Step

The palladium plating step in the preparation of the gold-on-palladium membrane of this Example 2 was the same as that described in Example 1.

Annealing Step

The annealing step in the preparation of the gold-on-palladium membrane of this Example 2 was the same as that described in Example 1.

Polishing Step

The membrane was polished on a robotic polisher from Acme manufacturing with a Trizact A3 belt from 3M under conditions set to provide desired polishing and surface properties of the polished surface. The Trizact belt and other related abrading media and method of their use are described in detail in U.S. Patent Application, Ser. No. 61/977,790, filed 10 Apr. 2014, entitled “A Method of Making a Supported Gas Separation Membrane.” This disclosure is incorporated herein by reference upon its publication

Repeating of Sets

The steps of palladium plating, washing, drying, annealing and polishing process was repeated until a leak-tight membrane was obtained. The series of steps was repeated four times to provide a leak-tight, sealed membrane at 100 psi. The membrane had a permeance of 41 Nm³/m²/hr/bar.

Gold Plating Step

The palladium plated membrane was abraded and placed in a gold plating bath containing of 1300 ml of 0.08% Chloroauric Acid. The bath temperature was maintained at 20° C. The membrane assembly was turned with overhead stirring motor at a rate of about 50 rpm. 1 ml of 30% hydrogen peroxide (H₂O₂) was delivered via pipette to the center of the gold plating bath. After two hours, 0.25 ml of 30% hydrogen peroxide was added in the same manner.

After the gold plating step was completed, the membrane was placed in a total volume (1300 ml) of DI water for an hour, thoroughly rinsed with DI water, and dried at 140° C. The gold plated membrane was transferred to a hydrogen annealing oven whereby it was annealed in an atmosphere of pure H₂ for 6 hours at a temperature of 550° C. Following the hydrogen annealing of the gold plated membrane, it was then washed, dried and polished as described in Example 1. The gold plating process was repeated until the resulting membrane contained 8% gold with a thickness of 7.8 microns.

1. A method for preparing gold-on-palladium gas separation membrane system, wherein said method comprises:
providing a palladium layer upon a surface of a tubular porous substrate, defined by an outside diameter, a length, and a midpoint of said length, wherein said palladium layer has a mean surface roughness (Sa) of less than 2.5 micron;
submerging said tubular porous substrate having said palladium layer within a volume of a solution of chloroauric acid or a salt thereof; and
periodically introducing a volume of hydrogen peroxide into said solution while spinning said tubular porous substrate at a set rate and for a time period so as to deposit upon said palladium layer a gold layer of desired uniformity and a desired thickness.

2. A method as recited in claim 1, wherein said volume of hydrogen peroxide is introduced into said solution through conduit means for introducing said volume of hydrogen peroxide at a point in proximity to said tubular porous substrate.

3. A method as recited in claim 1, wherein said tubular porous substrate is oriented within said volume of said solution such that its length is non-parallel with the horizontal plane.

4. A method as recited in claim 1, wherein said point of introduction of said volume of hydrogen peroxide is within a range about said midpoint of said length of said tubular porous substrate.

5. A method as recited in claim 1, wherein said proximity of said point of introduction is such that the spinning motion of said tubular porous substrate within said solution assists in mixing of said volume of hydrogen peroxide with said volume of said solution.

6. A method as recited in claim 1, wherein said proximity of said point of introduction is upwardly to 3 inches from said outside diameter of said tubular porous substrate.

7. A method as recited in claim 1, wherein said set rate is in the range of from 30 rpm to 150 rpm.

8. A method as recited in claim 1, wherein said volume of hydrogen peroxide introduced into said volume of said solution is such as to provide a concentration of hydrogen peroxide in the gold plating solution in the range of from 0.01 wt % to 0.1 wt %.

9. A method as recited in claim 1, wherein said tubular porous substrate is oriented with said volume of said solution such that its length is either acute and obtuse or right to the horizontal plane at an angle in the range of from 45° to 135°.
